(19) United States
(12) Patent Application Publication
(10) Pub. No.: US 2008/0165111 A1
(43) Pub. Date: Jul. 10, 2008

(54) DISPLAY PANEL AND DISPLAY APPARATUS USING THE SAME AND CONTROL-SIGNAL DRIVING METHOD THEREOF

(75) Inventor: Feng-Ting Pai, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: NOVATEK MICROELECTRONICS CORP., Hsinchu (TW)

(21) Appl. No.: 11/690,843

(22) Filed: Mar. 25, 2007

(30) Foreign Application Priority Data
Jan. 5, 2007 (TW) 96100458

(51) Int. Cl. G09G 3/36

(52) U.S. Cl. 345/100

(57) ABSTRACT

A display panel and a display apparatus using the same and a control-signal driving method thereof are provided. Each data line of the display panel includes two sub-data lines and both sub-data lines interlace to connect the pixels thereof. When using the column inversion to drive the sub-data lines, it may have the dot inversion of frame quality or 2 line inversion (2V1H) of frame quality, and the horizontal scan line has enough time to charge electricity, and a memory is not required to pre-store data of the half frame at transmitting data period, so that the cost can be reduced. And each sub-data line at the same frame only has one driving polarity, it does not reverse driving polarity frequently, and therefore the display apparatus consumes less power.

### CROSS-REFERENCE TO RELATED APPLICATION

This application claims the priority benefit of Taiwan application serial no. 96100458, filed Jan. 5, 2007. All disclosure of the Taiwan application is incorporated herein by reference.

### BACKGROUND OF THE INVENTION

1. Field of the Invention

The present invention generally relates to a display apparatus, and more particularly, to a display panel and a display apparatus thereof capable of improving the charging time of horizontal scanning lines and reduce the power consumption.

2. Description of Related Art

Because of the physical characteristics of the liquid crystal, thin film transistor liquid crystal displays (TFT-LCDs) have a slower response speed compared to the traditional cathode ray tube (CRT) displays when displaying the motion images. In order to improve the dynamic motion blur, a technology of impulse type display is used by a method of black insertion to reduce the motion blur, which is similar to the display theory of the traditional cathode ray tube displays. It also can increase the frame rate or refresh rate of the frames to shorten the integration of the visual time, which can decrease the blur edge. In addition, with a trend of using double refresh rate (120 Hz), many problems arise, such as time length of each row of horizontal lines changes by half, which may lead to a lack of charge time especially in the case of high resolution. In the case of double refresh rate, in order to properly drive the display panel, the driving method of dot inversion (or 2 line inversion, 2V1H) is employed to increase the output negative/positive toggle rate of source driver, and the power consumption of the whole system may be enormously increased, and also substantial amount of heat may be generated. These may affect the stability of the system.

FIG. 1 is a schematic view showing a conventional high resolution display apparatus. Referring to FIG. 1, a display apparatus 100 includes a display panel 101 having top and bottom blocks. Horizontal scanning lines can be actuated independently by gate drivers at both sides thereof, respectively and the two blocks are being scanned synchronously. Because the time of each row of horizontal scanning lines (H_period) is equal to a reciprocal of a product of refresh rate and the scanning number of horizontal scanning lines (V_toat1), and the refresh rate is increased by two folds in high resolution. If the display panel 101 is not divided into the upper and bottom blocks, the scanning time of horizontal scanning lines is reduced by half, and the time of charge which has achieved to its utmost will become insufficient. Due to two fold increase in the refresh rate and the two blocks division of the display panel 101, the scanning quantities of each horizontal scanning line changes by half in order to maintain the scanning time of each horizontal scanning line unchanged. Wherein, a driving method of frame inversion can be employed in the structure of the display panel 101 as shown in FIG. 2. M rows of scanning lines are illustrated by A1˜AM, where M is a positive integer. Each data line needs to be switched frequently when the two independent blocks are driven synchronously.

FIG. 3 shows a data mapping view of the display panel. When the two blocks are driven synchronously, the scanning line A1 of the top block and the scanning line A_{M/2+1} of the bottom block are driven synchronously for the first time, then the scanning lines of the two blocks are driven in sequence from up to bottom until the scanning line A_{M/2} of the top block and the scanning line AM of the bottom block are driven synchronously for the last time. However, the conjoint part of the two blocks may generate image asymmetry, and the reversion times of positive/negative polarity output from the source driver are increased. Moreover, the data of one of the two blocks (such as the top block) must be stored in a frame buffer, and at least half of the data of images is required to be stored. This may increase the cost of the whole system.

### SUMMARY OF THE INVENTION

The present invention provides a display panel capable of improving the time for charging enough electricity and reducing power loss, and may have the dot inversion of frame quality when operated in a high refresh rate.

The present invention further provides a display apparatus having the frame quality of dot inversion, and can improve the time for charging enough electricity and reduce power loss when operated in a high refresh rate.

The present invention also provides a display panel capable of improving the time for charging enough electricity and reducing power loss, and may have the frame quality of 2 line inversion (2V1H) when operated in a high refresh rate.

The present invention also provides a display apparatus having frame quality of 2 line inversion (2V1H), and capable of improving time for charging enough electricity and reducing power loss when operated in a high refresh rate.

To achieve the above-mentioned features and other objectives of the present invention, a display panel adapted to a flat display apparatus is provided. The display panel includes M rows of scanning lines, N columns of data lines and M*N pixels, where M and N are positive integers. Each data line includes a first sub-data line and a second sub-data line, and the M*N pixels are aligned in a matrix. A pixel of the matrix in row i and column j can be illustrated as P(i, j), where i and j are integers, and 1≦i≦M, and 1≦j≦N. The first sub-data line of column is coupled to the pixel P(i, j), and the second sub-data line of column j is coupled to the pixel P(i+1, j).

According to another embodiment of the present invention, a display apparatus is provided. The display apparatus includes a timing controller, a first source driver, a second source driver and a display panel. The gate driver, the first source driver, and the second source driver are coupled to the timing controller, and the display panel is coupled between the gate driver and the source drivers. The display panel includes M rows of scanning lines, N columns of data lines and M*N pixels, where M and N are positive integers. The M rows of scanning lines are driven by the gate driver. Each data line of the N columns of data lines includes a first sub-data line driven by the first source driver and a second sub-data line driven by the second source driver. The M*N pixels are aligned in a matrix. A pixel of the matrix in row i and column j can be illustrated as P(i, j), where i and j are integers, and 1≦i≦M and 1≦j≦N. The first sub-data line of column j is coupled to the pixel P(i, j), and the second sub-data line of column j is coupled to the pixel P(i+1, j). The timing controller controls the gate driver, the first source driver and the second source driver, when the scanning line coupled to the P(i, j) is actuated, the scanning line coupled to the P(i+1, j) is also actuated, and data is driven to the first sub-data line of column j by the first source driver, and data is driven to the second sub-data line of column j by the second source driver.

According to another embodiment of the present invention, a display panel adapted to flat display apparatus is provided. The display panel includes M rows of scanning lines, N columns of data lines and M*N pixels, where M and N are positive integers. Each data line of the N columns of data lines includes a first sub-data line and a second sub-data line. The M*N pixels are aligned in a matrix, a pixel of the matrix in row i and column j can be illustrated as P(i, j), where i and j are integers, and 1≦i≦M and 1≦j≦N. The first sub-data line of column j is coupled to the pixels of P(i, j) and P(i+3, j), and the second sub-data line of column j is coupled to the pixels of P(i+1, j) and P(i+2, j).

According to another embodiment of the present invention, a display apparatus is provided. The display apparatus includes a timing controller, a gate driver, a first source driver, a second source driver and a display panel. The gate driver, the first source driver, and the second source driver are coupled to the timing controller, and the display panel is coupled between the gate driver and the source drivers. The display panel includes M rows of scanning lines, N columns of data lines and M*N pixels, where M and N are positive integers. The M rows of scanning lines are driven by the gate driver. Each data line of the N columns of data lines includes a first sub-data line driven by the first source driver and a second sub-data line driven by the second source driver. The M*N pixels are aligned in a matrix, a pixel of the matrix in row i and column j can be illustrated as P(i, j), where i and j are integers, and 1≦i≦M and 1≦j≦N. The first sub-data line of column j is coupled to the pixels of P(i,j) and P(i+3, j), and the second sub-data line of column j is coupled to the pixels of P(i+1, j) and P(i+2, j). The timing controller controls the gate driver, the first source driver and the second source driver, when the scanning line coupled to the pixel P(i, j) is actuated, the scanning line coupled to the pixel P(i+1, j) is also actuated, and then data of the pixel P(i, j) is driven to the first sub-data line of column j by the first source driver, and data of the pixel P(i+1, j) is driven to the second sub-data line of column j by the second source driver. When the scanning line coupled to the pixel P(i+2, j) is actuated, the scanning line coupled to the pixel P(i+3, j) is also actuated, and then data of the pixel P(i+3, j) is transferred to the first sub-data line of column j by the first source driver, and data of the pixel P(i+2, j) is transferred to the second sub-data line of column j by the second source driver.

Any data line of a display panel in the present invention is adopted to use two sub-data lines and both sub-data lines interlace to connect the pixels thereof. When using the column inversion to drive the sub-data lines, it may have the frame quality of dot inversion or frame quality of 2 line inversion (2V1H), and the horizontal scan line has enough time to charge electricity, and a large capacity memory is not required to pre-store data of the half frame during transmitting data period, so that the cost can be reduced. And each sub-data line in the same frame only has one driving polarity, it does not frequently reverse driving polarity, and therefore the power consumption of the display apparatus can be reduced.

### BRIEF DESCRIPTION OF THE DRAWINGS

These and other exemplary embodiments, features, aspects, and advantages of the present invention will be described and become more apparent from the detailed description of exemplary embodiments when read in conjunction with accompanying drawings.

FIG. 1 is a schematic view showing a structure of a conventional display apparatus.

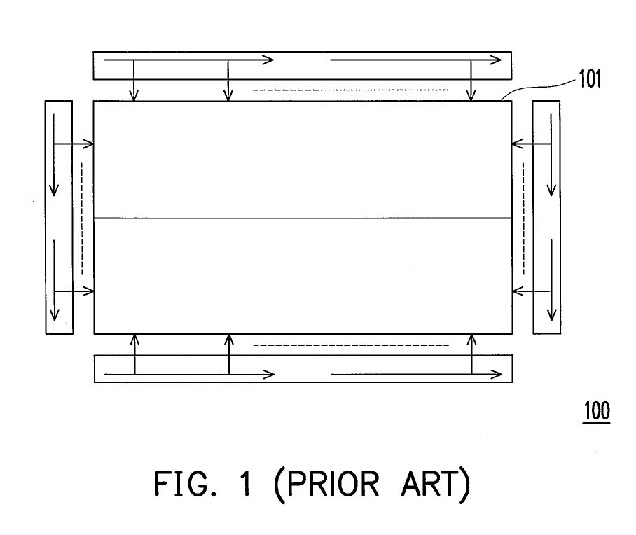

FIG. 2 is a schematic view showing a structure of a conventional display panel.

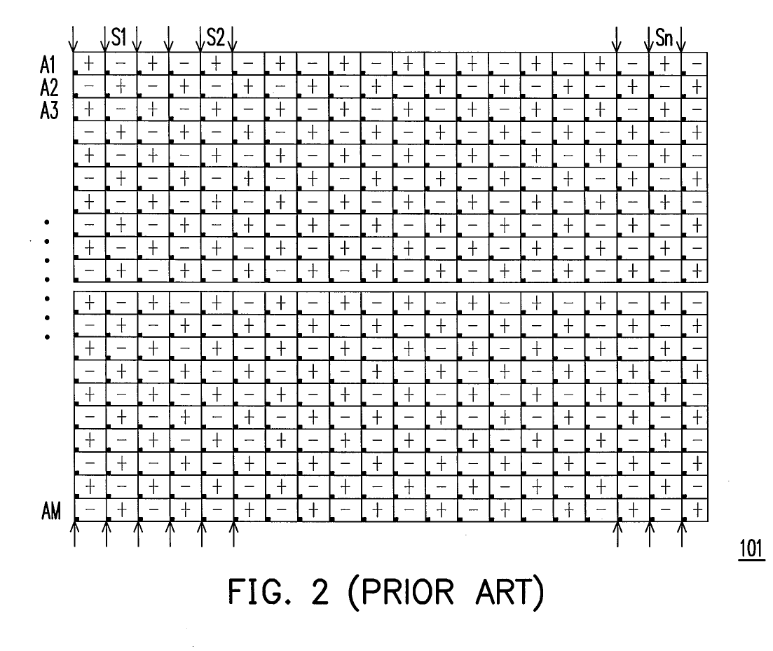

FIG. 3 is a data mapping view of a conventional display panel.

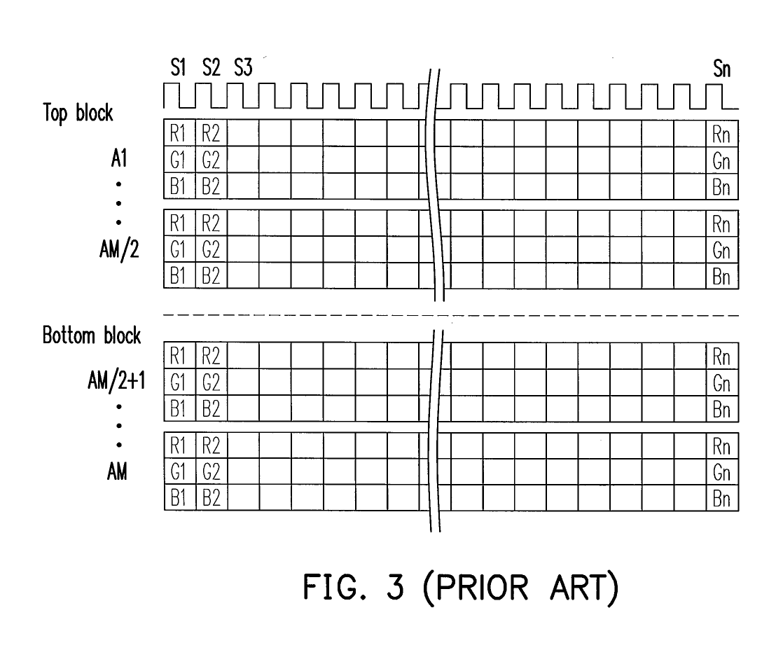

FIG. 4 is a schematic view showing a structure of a display apparatus according to an embodiment of present invention.

FIG. 5 is a schematic view showing a structure of data lines of the display panel of FIG. 4.

FIG. 6 is a schematic view of the display panel of FIG. 4.

FIG. 7 is a data mapping view of the display panel of FIG. 4.

FIG. 8 is a sequence chart of the gate driver of FIG. 4.

FIG. 9 is a schematic view showing a structure of data lines of a display apparatus according to another embodiment of present invention.

FIG. 10 is a schematic view of the display panel of FIG. 9.

FIG. 11 is a data mapping view of the display panel of FIG. 9.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

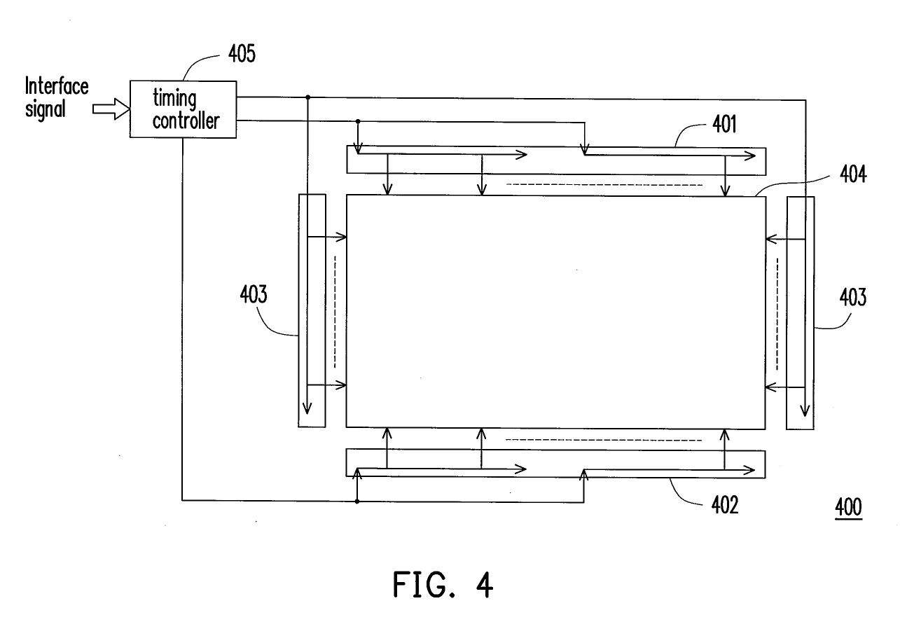

FIG. 4 illustrates a structure of a display apparatus system according to an embodiment of the present invention. The display apparatus 400 includes a timing controller 405, source drivers 401,402, a gate driver 403 and a display panel 404. The gate driver 403 is coupled to the timing controller 405 and the source drivers 401 and 402 are coupled to the timing controller 405. The display panel 404 is coupled between the source drivers 401, 402 and the gate driver 403. The timing controller 405 controls the source drivers 401 and 402, and the gate driver 403.

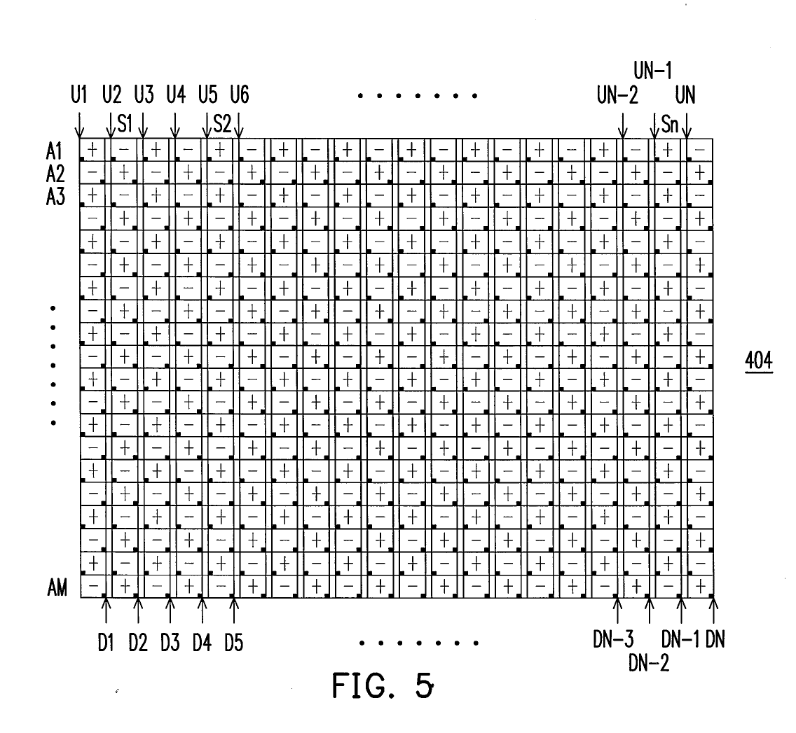

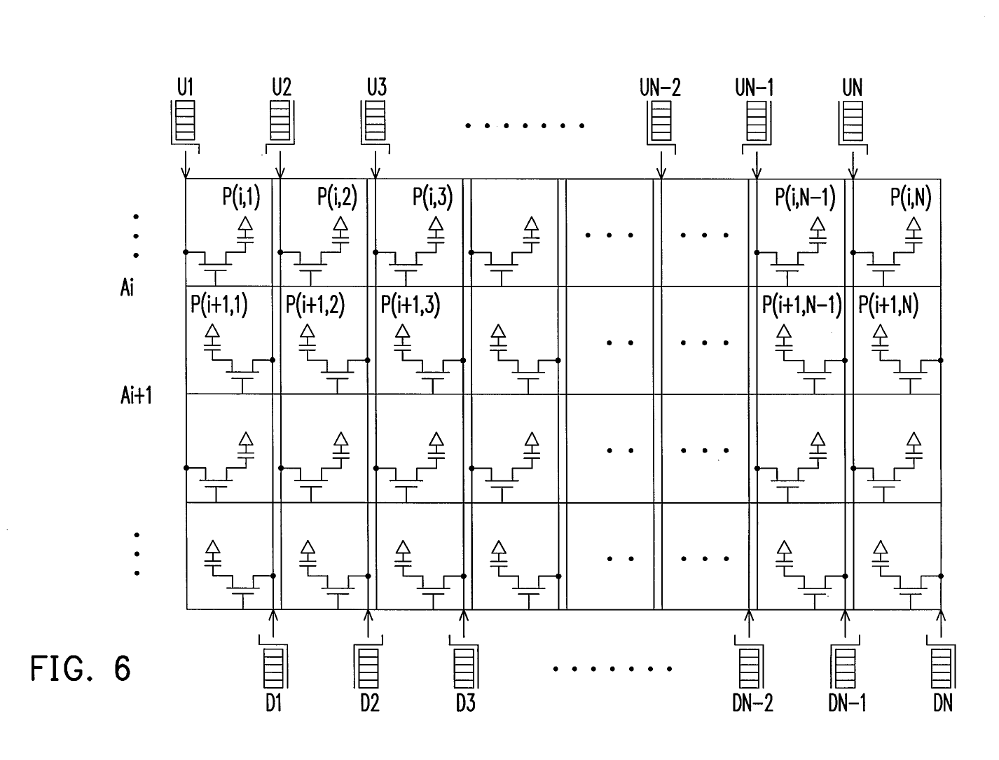

The display panel 404 is described in detail with reference to FIG. 5. FIG. 5 is a schematic view showing a structure of data lines of the display panel 404. The display panel 404 includes M rows of scanning lines A1-AM, N columns of data lines and M*N pixels, where M and N are positive integers. Each data line of the N columns of data lines includes a first sub-data line (U1˜UN) and a second sub-data line (D1˜DN). The first and second sub-data lines are driven by the source drivers 401, 402 respectively. FIG. 6 shows a schematic view of the display panel 404. Because the M*N pixels are aligned in a matrix, a pixel of the matrix in row i and column j is provided as P(i, j), where i and j are integers, and 1≦i≦M and 1≦j≦N. The first sub-data line of column j is coupled to the pixel P(i, j), and the second sub-data line of column j is coupled to the pixel P(i+1, j). When the scanning line Ai coupled to the pixel P(i, j) is actuated, the scanning line Ai+1 coupled to the pixel P(i+1, j) is also actuated. The source drivers 401 and 402 (shown in FIG. 4) drive data to the first sub-data line and the second sub-data line of column j respectively. That is, when the scanning lines Ai is actuated, the scanning lines Ai+1 is also actuated in a period of a gate impulse, and the timing controller 405 (shown in FIG. 4) controls the source drivers 401, 402 to simultaneously drive data to the first sub-data lines (U1˜UN) and the second sub-data lines (D1˜DN), respectively. Moreover, the first sub-data line of column j transfers data to the pixel P(i, j), and the second sub-data line of column j transfers data to the pixel P(i+1, j).

A driving method is illustrated in FIGS. 5 and 6. The signals “±” are provided to indicate positive/negative driving polarity respectively of the first sub-data lines (U1˜UN) and the second sub-data lines (D1˜DN). In a same frame, the first sub-data lines U1, U3, U5, . . . UN-3, UN-1 and the second sub-data lines D₂, D₄, D₆, . . . DN-2, DN are driven positively, and the first sub-data lines U2, U4, U6, . . . UN-2, UN and the second sub-data lines D₁, D₃, D₅, . . . DN-3, DN-1 are driven negatively. When different scanning lines are actuated, the polarities of the first and the second sub-data lines are not required to be reversed. In the next frame, the polarities of the first and the second sub-data lines are reversed. That is, the first sub-data lines U1, U3, U5, . . . UN-3, UN-1 and the second sub-data lines D₂, D₄, D₆, . . . DN-2, DN are driven negatively, and the first sub-data lines U2, U4, U6, . . . UN-2, UN and the second sub-data lines D₁, D₃, D₅, . . . DN-3, DN-1 are driven positively. It will be apparent that in the same frame two adjacent pixels have the opposite driving polarities in either horizontal direction or vertical direction. Furthermore, the polarity of a same pixel is not reversed until entering into a next frame. The structure and driving method of each data line in the display panel 404, wherein the data line has two sub-data lines coupling crossly to the pixels thereof to achieve a best image quality of dot inversion even though the source driver is in a mode of column inversion. In addition, since the polarities of the data lines are not required to be reversed until entering a next scanning line, the number of span voltage is reduced, hence the power consumption is reduced.

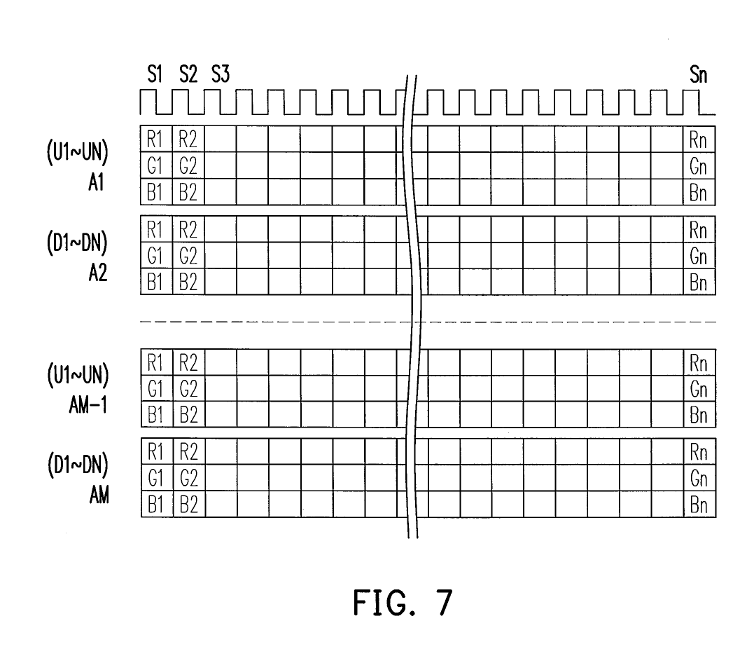

FIG. 7 shows a data mapping view of the display panel 404. When the scanning line A1 is actuated, the scanning line A2 is also actuated in a period of a gate impulse. The timing controller 405 (shown in FIG. 4) controls the source driver 401 (shown in FIG. 4) to sequentially read data of U1˜U3 (in impulse S1), U4˜U6 (in impulse S2) . . . UN-2˜UN (in impulse SN) and to drive the data to the first sub-data lines of the N columns of data lines simultaneously, and controls the source driver 402 to sequentially read data of D1˜D3 (in impulse S1), D4˜D6 (in impulse S2) . . . DN-2˜DN (in impulse SN) and to drive the data to the second sub-data lines of the N columns of data lines simultaneously. Similarly, when the scanning line AM-1 is actuated, the scanning line AM is also actuated in a period of a gate impulse, and the view of data mapping is shown in FIG. 7.

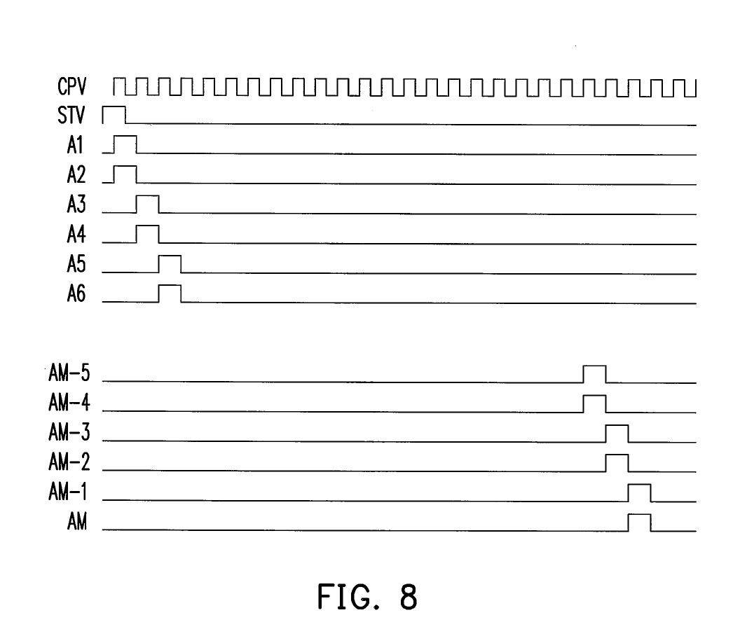

FIG. 8 is a sequence chart of the gate driver 403. After the timing controller 405 of the display apparatus 400 (shown in FIG. 4) sends an original gate impulse STV to actuate the gate driver 403, the gate driver 403 together with its gate impulse signal send M rows of scanning signals to actuate the M rows of scanning lines A1˜AM. The scanning signals are sent in M/2 times and the signals which actuate adjacent two rows of scanning lines are sent each time. As shown in FIG. 8, the scanning signals actuate the scanning lines A1˜A2, A3˜A4, . . . , AM-1˜AM in sequence. In this mode, because each row of the horizontal scanning lines is equal to a reciprocal of a product of frame refresh rate and the scanning number of the horizontal scanning lines, the refresh rate in high resolution is increased by two folds, and the scanning number of the horizontal scanning lines is reduced by half, so the scanning time of the horizontal scanning lines is unchanged.

A method of driving the display panel is illustrated in FIG. 4 to FIG. 8. The method includes the following steps. At step S1, as shown in FIG. 8, when the original gate impulse STV is actuated, M rows of scanning signals are sent to actuate the scanning lines A1˜AM. Next, the scanning signals are sent in M/2 times to actuate adjacent two rows scanning lines by the scanning signals sent each time. At step S2, as shown in FIG. 7, when the scanning lines Ai and Ai+1 (such as A1 and A2 or AM-1 and AM shown in FIG. 7) are actuated, data is driven to N columns of data lines, and data is transferred to the pixel P(i, y) by the first sub-data line of column y, and then data is transferred to the pixel P(i+1, y) by the second sub-data line of column y, where y is a positive integer ranging from 1 to N.

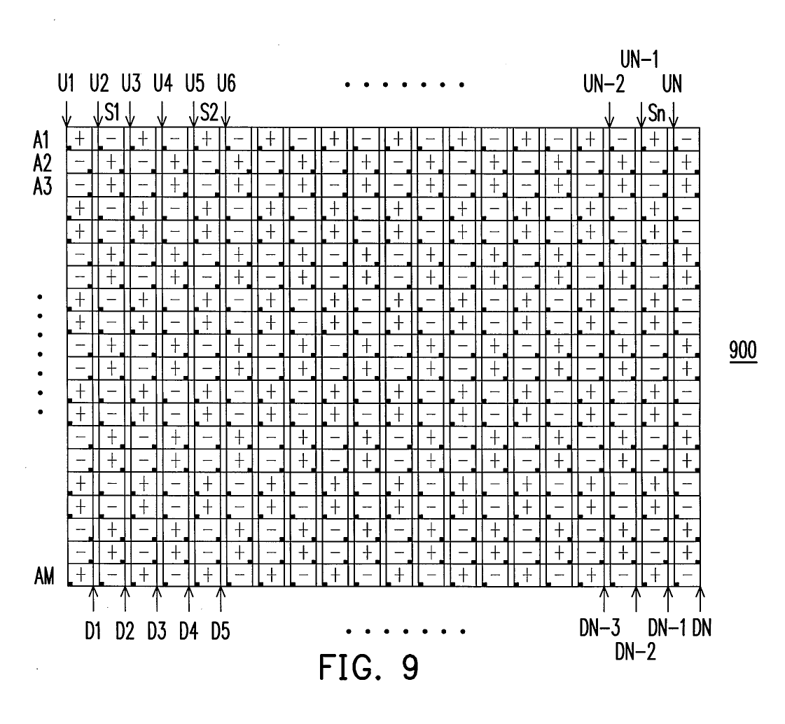

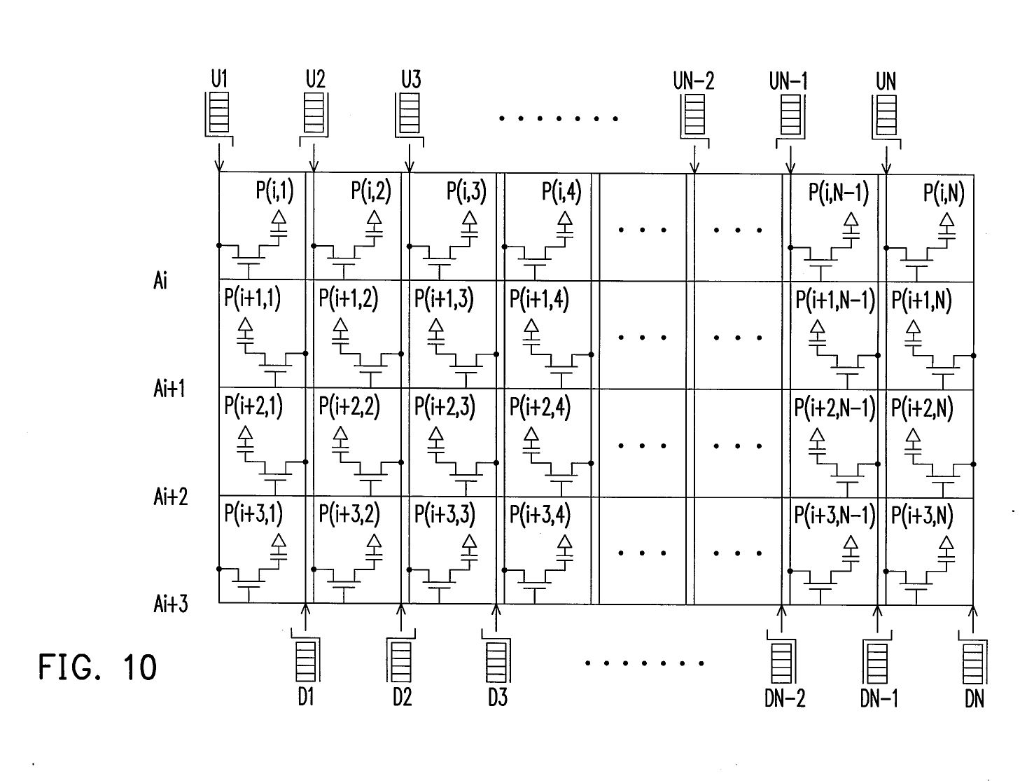

The schematic view of the structure of the display apparatus shown in FIG. 4 is used for illustrating another embodiment of the present invention, wherein data lines in the display panel have a different structure, and the sequence of driving data by the source driver is slightly different. The structure of the display panel of this embodiment is described in detail with reference to FIG. 9. FIG. 9 is a schematic view showing the structure of data lines of a display apparatus according to another embodiment of present invention. The display panel 900 includes M rows of scanning lines A1˜AM, N columns of data lines and M*N pixels, where M and N are positive integers. Each data line of the N columns of data lines includes a first sub-data line (U1˜UN) and a second sub-data line (D1˜DN). The first and second sub-data lines are driven by the source drivers 401, 402 respectively. FIG. 10 is a schematic view of the display panel. The M*N pixels are aligned in a matrix, a pixel of the matrix in row i and column j is provided as P(i, j), where i and j are integers, and 1≦i≦M and 1≦j≦N. The first sub-data line of column j is coupled to the pixels of P(i, j) and P(i+3, j), and the second sub-data line of column j is coupled to the pixels of P(i+1, j) and P(i+2, j). When the scanning line Ai coupled to the pixel P (i, j) is actuated, the scanning line Ai+1 coupled to the pixel P (i+1, j) is also actuated in a period of a gate impulse, and the first source driver 401 (shown in FIG. 4) drives data of pixel P(i, j) to the first sub-data line of column j, and the second source driver 402 (shown in FIG. 4) drives data of pixel P(i+1, j) to the second sub-data line of column j. When the scanning line Ai+2 coupled to the pixel P(i+2, j) is actuated, the scanning line Ai+3 coupled to the pixel P(i+3, j) is also actuated in a period of a gate impulse, and the first source driver 401 drives data of pixel P(i+3, j) to the first sub-data line of column j, and the second source driver 402 drives data of pixel P(i+2, j) to the second sub-data line of column j. That is, when the scanning line Ai is actuated, the scanning line Ai+1 is also actuated in a period of gate impulse. The timing controller 405 (shown in FIG. 4) controls the source driver 401 to drive the data to the first sub-data lines U1˜UN synchronously, and controls the source driver 402 to drive the data to the second sub-data lines D1˜DN synchronously. Wherein, the first sub-data line of column j transfers data to the pixel P(i, j), and the second sub-data line of column j transfers data to the pixel P(i+1, j). When the scanning line Ai+2 is actuated, the scanning line Ai+3 is also actuated in a period of a gate impulse. The timing controller 405 controls the source driver 401 to drive the data to the first sub-data lines U1˜UN synchronously, and controls the source driver 402 to drive the data to the second sub-data lines D1˜Dn synchronously. Wherein, the first sub-data line of column j transfers data to the pixel P(i+3, j), and the second sub-data line of column j transfers data to the pixel P(i+2, j).

A method of driving the display panel is illustrated with reference to FIGS. 9 and 10. The signals “±” are illustrated to indicate positive/negative driving polarities according to the first sub-data lines (U1˜UN) and the second sub-data lines (D1˜DN). In a same frame, the first sub-data lines U1, U3, U5, . . . UN-3, UN-1 and the second sub-data lines D₂, D₄, D₆, . . . DN-2, DN are driven positively, and the first sub-data lines U2, U4, U6, . . . UN-2, UN and the second sub-data lines D₁, D₃, D₅, . . . DN-3, DN-1 are driven negatively. The polarities of the first sub-data lines and the second sub-data lines are not required to be reversed when the scanning lines in different rows are actuated. The polarities of the first sub-data lines and the second sub-data lines are reversed when entering into a next frame, that is, the first sub-data lines U1, U3, U5, . . . UN-3, UN-1 and the second sub-data lines D₂, D₄, D₆, . . . DN-2, DN are driven negatively, and the first sub-data lines U2, U4, U6, . . . UN-2, UN and the second sub-data lines D₁, D₃, D₅, . . . DN-3, DN-1 are driven positively. It will be apparent that two adjacent pixels in a same frame have the opposite driving polarities in either horizontal direction or vertical direction. Moreover, when a same pixel enters a next frame, the driving polarity of the pixel is reversed. The structure and driving method of each data line in the display panel 900, wherein the data line has two sub-data lines crossly coupling to the pixels thereof to achieve a best image quality of 2 line inversion even though the source driver is in a mode of column inversion. In addition, since the polarities of the data lines are not required to be reversed when entering into a next scanning line, the number of span voltage is reduced, hence the power consumption is reduced.

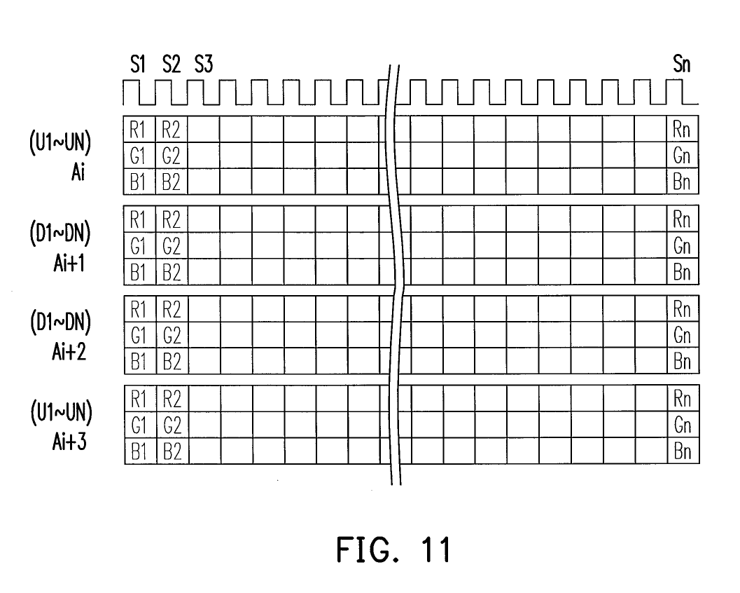

FIG. 11 shows a data mapping view of the display panel 900. When the scanning line Ai is actuated, the scanning line Ai+1 is also actuated in a period of gate impulse. The timing controller 405 (shown in FIG. 4) controls the source driver 401 (shown in FIG. 4) to sequentially read the data of U1˜U3 (in impulse S1), U4˜U6 (in impulse S2) . . . UN-2˜UN (in impulse SN) and drives data to the first sub-data lines of the N columns of data lines, and controls the source driver 402 to sequentially read the data of D1˜D3 (in a impulse S1), D4˜D6 (in impulse S2) . . . DN-2˜DN (in impulse SN) and drives data to the second sub-data lines of the N columns of data lines. Similarly, when the scanning line Ai+2 is actuated, the scanning line Ai+3 is also actuated in a gate impulse, and the view of data mapping is shown in FIG. 11.

A method of driving the display panel is illustrated with reference to FIG. 9 to FIG. 11. The method includes the following steps. At step S1, as shown in FIG. 8, when the original gate impulse STV is actuated, M rows of scanning signals are sent to actuate the scanning lines A1˜AM. Next, the scanning signals are sent in M/2 times to actuate adjacent two rows of scanning lines by the scanning signals sent each time. At step S2, as shown in FIG. 11, when the scanning lines Ai and Ai+1 are actuated, data is driven to the N columns of data lines, data is then transferred to the pixel P(i, y) by the first sub-data line of column y, and then data is transferred to the pixel P(i+1, y) by the second sub-data line of column y. When the scanning lines Ai+2 and Ai+3 are actuated, data is transferred to the pixel P(i+2, y) by the second sub-data line of column y, and then data is transferred to the pixel P(i+3, y) by the first sub-data line of column y, where y is a positive integer ranging from 1 to n.

As mentioned above, any data line of this display panel includes two sub-data lines and both sub-data lines interlace to connect the pixels thereof. When two adjacent scanning lines are actuated each time and the sub-data lines are driven in the manner of the column inversion, it may have the dot inversion of frame quality or 2 line inversion (2V1H) of frame quality, and each of the horizontal scan lines has enough time to charge electricity. Moreover, a large capacity memory is not required to pre-store data of the half frame during transmitting data period, so the cost is reduced. And each sub-data line in the same frame only has one driving polarity, it does not reverse driving polarity frequently, thereby the power consumption of the display apparatus is decreased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display panel, comprising:
M rows of scanning lines, wherein M is a positive integer;
N columns of data lines, wherein N is a positive integer, and each data line comprises a first sub-data line and a second sub-data line; and
M*N pixels aligned in a matrix, a pixel of the matrix in row i and column j being represented as P(i, j), wherein i and j are integers, and 1≦i≦M and 1≦j≦N, the first sub-data line of column j is coupled to the pixel P(i, j), and the second sub-data line of column j is coupled to the pixel P(i+1, j).

2. The display panel according to claim 1, wherein the display panel is coupled to a gate driver, a first source driver and a second source driver, wherein the scanning lines are driven by the gate driver, the first sub-data line of each column is driven by the first source driver and the second sub-data line of each column is driven by the second source driver, and when the scanning line coupled to the pixel P (i, j) is actuated, the scanning line coupled to the pixel P (i+1, j) is also actuated in a period of a gate impulse, and data is driven to the first sub-data line of column j by the first source driver and then to the second sub-data line of column j by the second source driver.

3. A display apparatus, comprising:
a timing controller;
a gate driver, coupled to the timing controller;
a first source driver, coupled to the timing controller;
a second source driver, coupled to the timing controller; and
a display panel, coupled between the gate driver and the source drivers, comprising:
M rows of scanning lines driven by the gate driver, wherein M is a positive integer;
N columns of data lines, wherein N is a positive integer, each data line comprises a first sub-data line driven by the first source driver and a second sub-data line driven by the second source driver; and
M*N pixels aligned in a matrix, a pixel of the matrix in row i and column j being represented as P(i, j), wherein i and j are integers, and 1≦i≦M and 1≦j≦N, and the first sub-data line of column j is coupled to the pixel P(i, j) and the second sub-data line of column j is coupled to the pixel P(i+1, j);
Wherein, the timing controller controls the gate driver, the first source driver and the second source driver, when the scanning line coupled to the pixel P(i, j) is actuated, the scanning line coupled to the pixel P(i+1, j) is also actuated in a period of a gate impulse, and the first source driver drives data to the first sub-data line of column j and the second source driver drives data to the second sub-data line of column j.

4. The display apparatus according to claim 3, wherein when an original gate impulse signal is actuated, the gate driver sends M rows of scanning signals to actuate the M rows of scanning lines, and the scanning signals are sent in M/2 times and the scanning signals which actuate adjacent two rows of scanning lines are sent each time.

5. The display apparatus according to claim 4, wherein when the scanning lines of rows i and i+1 are actuated, the first sub-data line of column y transfers data to the pixel P(i, y), and the second sub-data line of column y transfers data to the pixel P(i+1, y), where y is a positive integer ranging from 1 to N.

6. A display apparatus, comprising:
a timing controller;
a gate driver, coupled to the timing controller;
a first source driver, coupled to the timing controller;
a second source driver, coupled to the timing controller; and
a display panel, coupled between the gate driver and the source drivers, comprising:
M rows of scanning lines driven by the gate driver, wherein M is a positive integer;
N columns of data lines, wherein N is a positive integer, and each data line comprises a first sub-data line driven by the first source driver and a second sub-data line driven by the second source driver; and
M*N pixels aligned in a matrix, a pixel of the matrix in row i and column j being represented as P(i, j), wherein i and j are integers, and 1≦i≦M and 1≦j≦N, the first sub-data line of column j is coupled to the pixel P(i, j) and the second sub-data line of column j is coupled to the pixel P(i+1, j);
wherein, the timing controller controls the gate driver, when the scanning line of row i is actuated, the scanning line of row i+1 is also actuated, and the timing controller controls the first source driver to drive data to the first sub-line of the data lines synchronously and controls the second source driver to drive data to the second sub-line of the data lines synchronously.

7. The display apparatus according to claim 6, wherein when an original gate impulse signal is actuated, the gate driver sends M rows of scanning signals to actuate the M rows of scanning lines, and the scanning signals are sent in M/2 times and the scanning signals which actuate adjacent two rows of scanning lines are sent each time.

8. A method of driving controlling signals, adapted for display apparatus comprising M rows of scanning lines, N columns of data lines and M*N pixels, each data line comprising a first sub-data line and a second sub-data line, the pixels being aligned in a matrix, a pixel of the matrix in row i and column j being represented as P(i, j), and the first sub-data line of column j being coupled to the pixel P(i, j) and the second sub-data line of column j being coupled to the pixel P(i+1, j), wherein M, N, i, and j are positive integers and 1≦i≦M and 1≦j≦N; the method comprising:
sending M rows of scanning signals to actuate the M rows of scanning lines when an original gate impulse signal is actuated, and sending the scanning signals in M/2 times and actuating adjacent two rows of scanning lines by the scanning signals sent each time;
transferring data to the pixel P(i, y) by the first sub-data line of column y, and transferring data to the pixel P(i+1, y) by the second sub-data line of column y when the scanning lines of rows i and i+1 are actuated, wherein y is a positive integer ranging from 1 to N.

9. A display panel, comprising:
M rows of scanning lines, wherein M is a positive integer;
N columns of data lines, wherein N is a positive integer, and each data line comprises a first sub-data line and a second sub-data line; and
M*N pixels aligned in a matrix, a pixel of the matrix in row i and column j being represented as P(i, j), wherein i and j are integers, and 1≦i≦M and 1≦j≦N, and the first sub-data line of column j is coupled to the pixels of P(i, j) and P(i+3, j), and the second sub-data line of column j is coupled to the pixels of P(i+1, j) and P(i+2, j).

10. The display panel according to claim 9, the display panel is coupled to a gate driver, a first source driver and a second source driver, wherein the scanning lines are driven by the gate driver, the first sub-data line of each column is driven by the first source driver and the second sub-data line of each column is driven by the second source driver, and when the scanning line coupled to the pixel P(i, j) is actuated, the scanning line coupled to the pixel P(i+1, j) is also actuated in a period of a gate impulse, and data of pixel P(i, j) is driven to the first sub-data line of column j by the first source driver, and data of pixel P(i+1, j) is driven to the second sub-data line of column j by the second source driver, and when the scanning line coupled to the pixel P (i+2, j) is actuated, the scanning line coupled to the pixel P (i+3, j) is also actuated in a period of a gate impulse, and data of pixel P(i+3, j) is driven to the first sub-data line of column j by the first source driver, and data of pixel P(i+2, j) is driven to the second sub-data line of column j by the second source driver.

11. A display apparatus, comprising:
a timing controller;
a gate driver, coupled to the timing controller;
a first source driver, coupled to the timing controller;
a second source driver, coupled to the timing controller; and
a display panel, coupled between the gate driver and the source drivers, comprising:
M rows of scanning lines driven by the gate driver, wherein M is a positive integer;
N columns of data lines, wherein N is a positive integer, each data line comprises a first sub-data line driven by the first source driver and a second sub-data line driven by the second source driver; and
M*N pixels aligned in a matrix, a pixel of the matrix in row i and column j being-represented as P(i, j), wherein i and j are integers, and 1≦i≦M and 1≦j≦N, the first sub-data line of column j is coupled to the pixels of P(i, j) and P(i+3, j), and the second sub-data line of column j is coupled to the pixels of P(i+1, j) and P(i+2, j);
wherein the timing controller controls the gate driver, the first source driver and the second source driver, and when the scanning line coupled to the pixel P(i, j) is actuated, the scanning line coupled to the pixel P(i+1, j) is also actuated , and data of pixel P(i, j) is driven to the first sub-data line of column j by the first source driver, data of pixel P(i+1, j) is driven to the second sub-data line of column j by the second source driver, and when the scanning line coupled to the pixel P(i+2, j) is actuated, the scanning line coupled to the pixel P(i+3, j) is also actuated, and data of pixel P(i+3, j) is driven to the first sub-data line of column j by the first source driver, data of pixel P(i+2, j) is driven to the second sub-data line of column j by the second source driver.

12. The display apparatus according to claim 11, wherein when a gate start impulse signal is actuated, the gate driver sends M rows of scanning signals to actuate the M rows of scanning lines, and the scanning signals are sent in M/2 times and the scanning signals which actuate adjacent two rows of scanning lines are sent each time.

13. The display apparatus according to claim 12, wherein when the scanning lines of rows i and i+1 are actuated, the first sub-data line of column y transfers data to the pixel P(i, y) and the second sub-data line of column y transfers data to the pixel P(i+1, y), and when the scanning lines of rows i+2 and i+3 are actuated, the first sub-data line of column y transfers data to the pixel P(i+3, y) and the second sub-data line of column y transfers data to the pixel P(i+2, y), wherein y is a positive integer ranging from 1 to N.

14. A display apparatus, comprising:
a timing controller;
a gate driver, coupled to the timing controller;
a first source driver, coupled to the timing controller;
a second source driver, coupled to the timing controller; and
a display panel, coupled between the gate driver and the source drivers, comprising:
M rows of scanning lines driven by the gate driver, wherein M is a positive integer;
N columns of data lines, wherein N is a positive integer, each data line comprises a first sub-data line driven by the first source driver and a second sub-data line driven by the second source driver; and
M*N pixels aligned in a matrix, a pixel of the matrix in row i and column j being illustrated as P(i, j), wherein i and j are integers, and 1≦i≦M and 1≦j≦N, the first sub-data line of column j and the scanning line of row i is coupled to the pixel of P(i, j), and the second sub-data line of column j and the scanning line of row i+1 is coupled to the pixel of P(i+1, j), the second sub-data line of column j and the scanning line of row i+2 are coupled to the pixel of P(i+2, j), and the first sub-data line of column j and the scanning line of row i+3 are coupled to the pixel of P(i+3, j);
wherein the timing controller controls the gate driver, when the scanning line of row i is actuated, the scanning line of row i+1 is also actuated in a period of a gate impulse, when the scanning line of row i+2 is actuated, the scanning line of row i+3 is also actuated in a period of a gate impulse, and the timing controller controls the first source driver to drive data to the first sub-data line synchronously and controls the second source driver to drive data to the second sub-data line synchronously.

15. The display apparatus according to claim 14, wherein when a gate start impulse signal actuates, the gate driver sends M rows of scanning signals to actuate the M rows of scanning lines, and the scanning signals are sent in M/2 times and the scanning signals which actuate adjacent two rows of scanning lines are sent each time.

16. A method of driving controlling signals, adapted for a display apparatus comprising M rows of scanning lines, N columns of data lines and M*N pixels, each data line comprising a first sub-data line and a second sub-data line, the pixels being aligned in a matrix, a pixel of the matrix in row i and column j being represented as P(i, j), and the first sub-data line of column j being coupled to the pixels of P(i, j) and P(i+3, j), and the second sub-data line of column j being coupled to the pixels of P(i+1, j) and P(i+2, j), wherein M, N, i, and j are positive integers and 1≦i≦M and 1≦j≦N; the method comprising:
sending M rows of scanning signals to actuate the M rows of scanning lines when a gate start impulse signal is actuated, and sending the scanning signals in M/2 times and actuating adjacent two rows of scanning lines by the scanning signals sent each time;
transferring data to the pixel P(i, y) by the first sub-data line of column y, and transferring data to the pixel P(i+1, y) by the second sub-data line of column y when the scanning lines of rows i and i+1 are actuated, wherein when the scanning lines of rows i+2 and i+3 are actuated, data is transferred to the pixel P(i+3, y) by the first sub-data line of column y, and data is then transferred to the pixel P(i+2, y) by the second sub-data line of column y, wherein y is a positive integer ranging from 1 to N.
